(19) United States
(12) Patent Application Publication
(10) Pub. No.: US 2024/0295986 A1
(43) Pub. Date: Sep. 5, 2024

(54) STORAGE CONTROLLER, STORAGE DEVICE INCLUDING THE SAME, AND OPERATING METHOD THEREOF

(71) Applicant: SAMSUNG ELECTRONICS CO., LTD., Suwon-si (KR)

(72) Inventors: Hyunjoon YOO, Suwon-si (KR); Heeseok EUN, Suwon-si (KR); Jinwook LEE, Suwon-si (KR); Seungcheol LEE, Suwon-si (KR)

(73) Assignee: SAMSUNG ELECTRONICS CO., LTD., Suwon-si (KR)

(21) Appl. No.: 18/238,856

(22) Filed: Aug. 28, 2023

(30) Foreign Application Priority Data
Mar. 3, 2023 (KR) 10-2023-0028649

(51) Int. Cl. G06F 3/06

(52) U.S. Cl. CPC G06F 3/0656; G06F 3/0604; G06F 3/0679

(57) ABSTRACT

A storage device includes: a plurality of non-volatile memory devices; a buffer configured to store user data and event data of a vehicle; a parity generating circuit configured to generate parity data; and a controller configured to: generate at least one user data segment corresponding to at least one first segment from a plurality of first segments based on the user data, generate, based on predetermined information generated in a state in which at least one user data segment is generated, at least one event data segment based on the event data corresponding to at least one first segment from the plurality of first segments that is different from the first segment corresponding to the user data segment, and store a stripe comprising the at least one user data segment, the at least one event data segment, and the parity data in the plurality of non-volatile memory devices.

### CROSS-REFERENCE TO RELATED APPLICATION

This application claims priority to and the benefit of Korean Patent Application No. 10-2023-0028649 filed in the Korean Intellectual Property Office on Mar. 3, 2023, the entire contents of which are incorporated herein by reference.

### BACKGROUND

### 1. Field

The disclosure relates to a storage controller, a storage devices including the same, and an operating method thereof.

### 2. Description of the Related Art

Redundant array of inexpensive disks (RAID) is a method mainly used in storage media such as a server that has important data. The RAID may include simply distributing data into a plurality of storage media and simultaneously performing input/output, duplicating and storing the same data in the plurality of storage media, or storing a parity in one or more storage media among the plurality of storage media and being able to restore data with an error to normal data or an error occurs in data stored in other storage media.

Storage devices for a vehicle may also use the RAID for data reliability. A stripe may be formed to store data in a RAID manner. However, if there is insufficient data to form a full stripe, the stripe may be not flushed. In this case, the data stored in a buffer may be lost due to internal or external factors in the vehicle.

### SUMMARY

Some embodiments may provide a storage controller, a storage device including the storage controller, and an operating method of the storage device for preventing loss of data.

According to one or more embodiments, a storage device comprises: a plurality of non-volatile memory devices each configured to store a respective segment from a plurality of segments forming a stripe, the plurality of segments comprising a plurality of first segments and at least one second segment; a buffer configured to store user data and event data of a vehicle; a parity generating circuit configured to generate parity data corresponding to the at least one second segment based on data corresponding to the plurality of first segments; and a controller configured to: generate at least one user data segment corresponding to at least one first segment from the plurality of first segments based on the user data, generate, based on predetermined information generated in a state in which the at least one user data segment is generated, at least one event data segment based on the event data corresponding to at least one first segment from the plurality of first segments that is different from the first segment corresponding to the user data segment, and store a stripe comprising the at least one user data segment, the at least one event data segment, and the parity data in the plurality of non-volatile memory devices.

According to one or more embodiments, a storage controller of a storage device configured to be used in a storage system, the storage controller comprising: a buffer configured to store user data and event data of the storage system; a parity generating circuit; and a redundant array of inexpensive disks (RAID) controller configured to: control a plurality of non-volatile memory devices comprised in the storage device in a RAID manner; form a partial stripe of a full stripe based on the user data; fill missing segments of the partial stripe with the event data based on predetermined information to form the full stripe; and store the full stripe comprising the user data, the event data, and parity data generated by the parity generating circuit in the plurality of non-volatile memory devices.

According to one or more embodiments, a method of operating a storage device comprises forming a stripe for storage in a redundant array of inexpensive disks (RAID) manner based on user data; in a state in which a partial stripe of the stripe is formed based on the user data, obtaining predetermined information; filling missing segments of the partial stripe with event data of a vehicle based on the predetermined information to form a full stripe; generating parity data based on the user data and the event data; and storing the full stripe comprising the user data, the event data, and the parity data in a plurality of non-volatile memory devices comprised in the storage device.

### BRIEF DESCRIPTION OF DRAWINGS

FIG. 1 is a diagram illustrating an example of a management system for a vehicle according to some embodiments.

FIG. 2 is a diagram illustrating an example of a management system for a vehicle according to some embodiments.

FIG. 3 is a flowchart illustrating an example of an operating method of a storage device for a vehicle according to some embodiments.

FIG. 4 is a drawing illustrating an example of an operating method of a storage device for a vehicle according to some embodiments.

FIG. 5 is a flowchart illustrating an example of an operating method of a storage device according for a vehicle to some embodiments.

FIG. 6 is a flowchart illustrating an example of an operating method of a storage device for a vehicle according to some embodiments.

FIG. 7 is a flowchart illustrating an example of an operating method of a storage device for a vehicle according to some embodiments.

FIG. 8 is a diagram illustrating an example of an operating method of a storage device for a vehicle according to some embodiments.

FIG. 9 is a diagram illustrating an example of an operating method of a storage device for a vehicle according to some embodiments.

### DETAILED DESCRIPTION OF EMBODIMENTS

In the following detailed description, only certain embodiments of the present disclosure have been shown and described, simply by way of illustration. As those skilled in the art would realize, the described embodiments may be modified in various different ways, all without departing from the spirit or scope of the present disclosure.

Accordingly, the drawings and description are to be regarded as illustrative in nature and not restrictive. Like reference numerals designate like elements throughout the specification. The sequence of operations or steps is not limited to the order presented in the claims or figures unless specifically indicated otherwise. The order of operations or steps may be changed, several operations or steps may be merged, a certain operation or step may be divided, and a specific operation or step may not be performed.

As used herein, the singular forms “a” and “an” are intended to include the plural forms as well, unless the context clearly indicates otherwise. Although the terms first, second, and the like may be used herein to describe various elements, components, steps and/or operations, these terms are only used to distinguish one element, component, step or operation from another element, component, step, or operation.

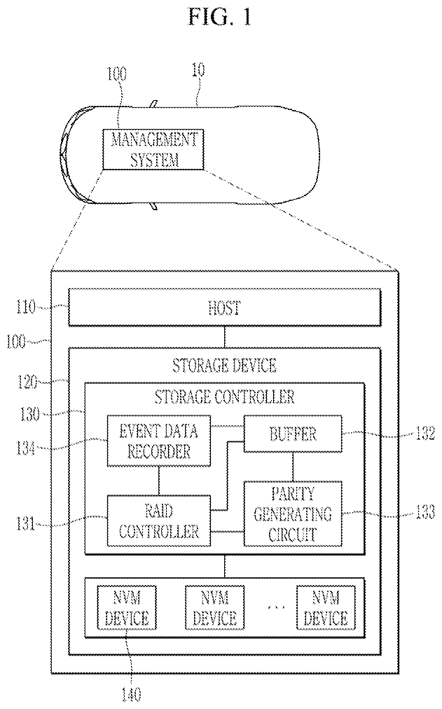

FIG. 1 is a diagram illustrating an example of a management system for a vehicle according to some embodiments.

Referring to FIG. 1, a management system 100 for a vehicle 10 may include a host 110 and a storage device 120. The management system 100 may be mounted either internally or externally on the vehicle 10.

The host 110 may control an overall operation of the management system 100. The storage device 120 may be used as a storage medium for the management system 100. In some embodiments, the storage device 120 may be removably connected to the host 110 or the vehicle 10. In some embodiments, the storage device 120 may be integrated within the host 110 or the vehicle 10, or may be non-removably connected to the host 110 or the vehicle 10.

The host 110 may provide user data provided by the vehicle 10 to the storage device 120 along with an input/output request (e.g., a write request). The user data may be any data generated by a driver or passenger operating the vehicle (e.g., operation of navigation system, operation of phone dialing, etc.) The host 110 may provide an input/output request (e.g., a read request) to the storage device 120 to read data from the storage device 120. In some embodiments, the user data may include user data generated by information processing in the vehicle 10 and/or user data provided from a terminal of an occupant of the vehicle 10. The vehicle 10 may provide event data to the storage device 120 using sensors and/or vehicle units. The sensors of the vehicle 10 may include sensors associated with the vehicle 10 including, by way of a non-limiting example, a speed sensor, a camera, an object detection sensor or any other suitable sensor known to one of ordinary skill in the art. The vehicle units may include units associated with driving the vehicle including, by way of a non-limiting example, an engine, a powertrain, a transmission, and a brake, and/or units associated with controlling the vehicle units including, by way of a non-limiting example, an electronic control unit (ECU) and a battery management system (BMS). In some embodiments, the sensors and/or vehicle units of the vehicle 10 may provide the event data to the storage device 120 directly, or to the storage device 120 through the host 110.

The storage device 120 may include a storage controller 130 and a plurality of non-volatile memory (NVM) devices 140. The storage controller 130 may control the plurality of NVM devices 140 in a RAID manner within the storage device 120. In some embodiments, the RAID manner may include a manner of restoring data on a parity basis. Controlling the plurality of NVM devices 140 in the RAID manner may ensure a safety of the storage device 120.

The storage controller 130 may store data in the plurality of NVM devices 140 and/or read data stored in the plurality of NVM devices 140 in response to an input/output request from the host 110. The storage controller 130 may process data for each stripe to store the data in the plurality of NVM devices 140 in the RAID manner. In one or more examples, a stripe comprises data divided across a set of NVM devices 140. The process of disk stripping comprises dividing a body of data into blocks and spreading the data blocks across multiple NMV devices, in a redundant array of independent disks. The storage controller 130 may form a stripe that includes user data corresponding to some NVM devices 140 among the plurality of NVM devices 140 and parity data generated from the user data, and store the stripe in the plurality of NVM devices 140. If the storage controller 120 fails to form the stripe with the user data at a time when a predetermined condition is satisfied, the storage controller 120 may form the stripe with the user data together with event data.

The NVM device 140 is a memory device that uses a non-volatile memory, and may include, by way of a non-limiting example, at least one non-volatile memory package or non-volatile memory chip. In some embodiments, the non-volatile memory may include a flash memory such as an NAND flash memory. In this case, the storage device 120 may be a solid-state drive (SSD), and the NVM device 140 may include at least one NAND flash package or NAND flash chip. In some embodiments, the non-volatile memory may include, by way of a non-limiting example, a phase-change memory, a resistive memory, a magnetoresistive memory, a ferroelectric memory, or a polymer memory. In some embodiments, each NVM device 140 may be assigned an identifier (ID) to identify that NVM device 140.

In some embodiments, the storage controller 130 may include a RAID controller 131, a buffer 132, a parity generating circuit 133, and an event data recorder 134.

The event data recorder 134 may receive event data of the vehicle 10 provided by the sensors and/or vehicle units of the vehicle 10. In some embodiments, the event data recorder 134 may store the event data in the buffer 132, or may store the event data in an internal memory of the event data recorder 134.

The buffer 132 may temporarily store the user data and/or the event data, and may flush (e.g., transfer) the temporarily-stored user data and/or event data to the NVM devices 140 in response to a flush command from the RAID controller 131. In some embodiments, the buffer 132 may include an area for storing the user data and an area for storing the event data. In some embodiments, the buffer 132 may include a volatile memory. The volatile memory may be, by way of a non-limiting example, a dynamic random-access memory (DRAM).

The RAID controller 131 may store the user data provided from the host 110 in the buffer 132 to form a stripe. By way of a non-limiting example, N NVM devices 140 may be provided to store N segments, respectively, forming the stripe. In this case, M NVM devices 140 may be used to store M segments (or first segments) among the N segments, and (N-M) NVM device(s) 140 may be used to store (N-M) segment(s) (or second segment(s)) corresponding to a parity (e.g., N and M are positive integers, and M is less than N). The RAID controller 131 may form the stripe with M user data (referred to as “user data segments”) corresponding to the M segments, respectively, and parity data generated from (or alternatively, based on) the M user data segments. If the RAID controller 131 is unable to form the stripe with the user data, the RAID controller 131 may fill event data (which may be referred to as “event data segment(s)”) in empty segment(s) among the M segments. The RAID controller 131 may form the stripe with the user data segments, the event data segment(s), and parity data generated from (or alternatively, based on) the data segments. In some embodiments, the RAID controller 131 may form the stripe with the event data segments and parity data generated from (or alternatively, based on) the event data segments.

The parity generating circuit 133 may generate the parity data from (or alternatively, based on) the data segments forming the stripe stored in buffer 132 under a control of the RAID controller 131. In some embodiments, the parity generating circuit 133 may generate the parity data by performing error correction code (ECC) encoding on the data segments forming the stripe stored in the buffer 132.

The event data received by the event data recorder 134 may include data related to an event of the vehicle 10. The event of the vehicle 10 may include the triggering of one or more sensors based on an accident of the vehicle 10. The event data may include, by way of a non-limiting example, driving information of the vehicle 10 and/or status information of the vehicle 10. The driving information of the vehicle 10 may include, by way of a non-limiting example, a speed of the vehicle 10, an acceleration in a forward direction of the vehicle 10, a lateral acceleration of the vehicle 10, a cumulative speed change of the vehicle 10, a maximum speed change of the vehicle 10, and/or an engine revolution of the vehicle 10. The status information of the vehicle 10 may include, by way of a non-limiting example, a throttle valve status of the vehicle 10, a steering wheel angle, a brake status, an anti-lock braking system (ABS) operating status, an electronic stability programme (ESP) operating status, a seat belt fastening status, an airbag warning light illumination status, and/or an airbag deployment time.

If the user data do not form the stripe after being stored in the buffer 132, the user may not be flushed to the NVM device 140. If the user data are retained for a long time after being stored in the buffer 132 without being flushed, an area of the buffer 132 may not be utilized efficiently, and the user data stored in buffer 132 may be lost due to an external or internal factor in the vehicle. In some embodiments, if the stripe cannot be formed with the user data stored in the buffer 132, the stripe may be formed with the user data along with the event data based on predetermined information. Thus, the user data may be flushed without being retained in the buffer for a long time.

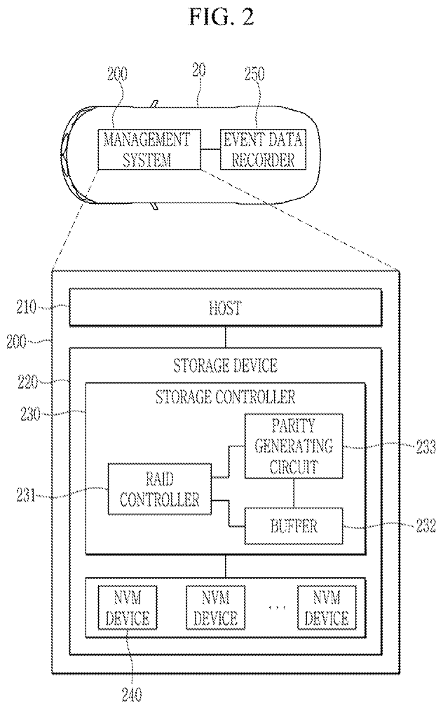

FIG. 2 is a diagram illustrating an example of a management system for a vehicle according to some embodiments. In FIG. 2, detailed descriptions of elements and operations similar as those described with reference to FIG. 1 are omitted.

Referring to FIG. 2, a management system 200 for a vehicle may include a host 210 and a storage device 220 for a vehicle, and may be mounted on a vehicle 20. The host 210 may control an overall operation of the management system 200. The storage device 220 may be used as a storage medium for the management system 200. The host 210 may provide user data provided by the vehicle 20 to the storage device 220 along with an input/output request (e.g., a write request). The host 210 may provide an input/output request (e.g., a read request) to the storage device 220 to read data from the storage device 220.

The vehicle 20 may be equipped with an event data recorder 250. In one or more examples, the event data recorder 250 may record event data provided by sensors and/or vehicle units of the vehicle 20. In some embodiments, the event data recorder 250 may provide the event data from the vehicle 20 to the storage device 220. In some embodiments, the host 210 may provide the event data of the vehicle 20 provided by the event data recorder 250 to the storage device 220.

The storage device 220 may include a storage controller 230 and a plurality of NVM devices 240. The plurality of NVM devices 240 may be controlled in a RAID manner within the storage device 220. In some embodiments, the storage controller 230 may include a RAID controller 231, a buffer 232, and a parity generating circuit 133. The buffer 232 may temporarily store the user data and/or the event data, and may flush the temporarily-stored user data and/or event data to the NVM devices 240 in response to a flush command from the RAID controller 231. The RAID controller 231 may store the user data from the host 210 in the buffer 232 to form a stripe. If the RAID controller 231 is unable to form a complete the stripe with the user data, the RAID controller 231 may fill the event data in empty segments. In one or more examples, the event data may be appended to the end of the user data to complete the formation of the stripe. In one or more examples, the event data may be interspersed with the user data to complete the formation of the stripe. The RAID controller 231 may form the stripe with user data segments, event data segment(s), and parity data generated from (or alternatively, based on) the data segments. The parity generating circuit 233 may generate the parity data from (or alternatively, based on) the data segments forming the stripe stored in the buffer 232 under a control of RAID controller 231.

As described above, if formation of the stripe cannot be completed with the user data, the storage device 220 may complete the formation the stripe with the user data along with the event data received from the event data recorder 250 mounted on the vehicle 20.

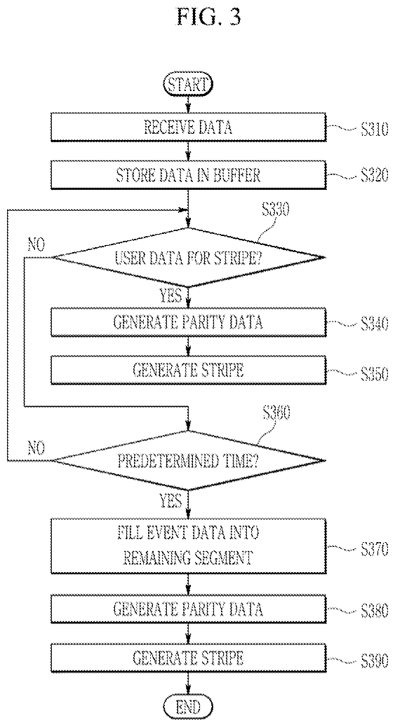

An operating method of a storage device for a vehicle according to various embodiments is described with reference to FIGS. 3 to 9. For convenience, the operating method is described using RAID 3 as an example, but other RAID levels may be used.

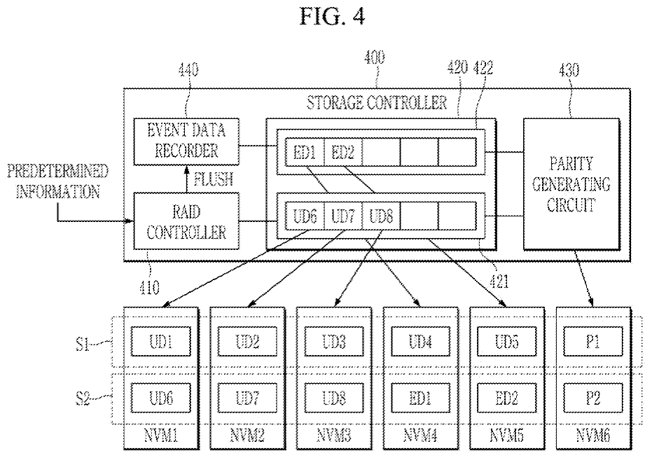

FIG. 3 is a flowchart illustrating an example of an operating method of a storage device for a vehicle according to some embodiments, and FIG. 4 is a drawing illustrating an example of an operating method of a storage device for a vehicle according to some embodiments. In FIGS. 3 and 4, in one or more examples, a storage device includes six NVM devices NVM1, NVM2, NVM3, NVM4, NVM5, and NVM6) and five NVM devices NVM1 to NVM5 are used for data storage and a remaining NVM device NVM6 is used for parity storage.

Referring to FIGS. 3 and 4, a storage controller 400, for example, a RAID controller 410 of a storage controller 400 may receive user data from a host in S310, and may store the received user data in a buffer 420 in S320. In some embodiments, the storage controller 400 may store the user data in a user data area 421 of the buffer 420. When storing the user data in the buffer 420, the storage controller 400 may generate data segments from the user data to be striped to a plurality of NVM devices NVM1 to NVM5 from (or alternatively, based on) the user data. The segment may be, by way of a non-limiting example, a chunk. In one or more examples, the user data may be segmented into N equal segment sizes. In one or more examples, the segmentation of the user data may be based on identification of individual fields of data, where the data is segmented along boundaries of the fields.

Further, in S320, the storage controller 400 may store event data from an event data recorder 440 in the buffer 420. In some embodiments, the event data recorder 440 may store the event data in the buffer 420 under a control of the RAID controller 410. In some embodiments, the event data recorder 440 may store the event data in the buffer 420 directly. In some embodiments, the event data recorder 440 may store the event data in an event data area 422 of the buffer 420. When storing the event data in the buffer 420, the storage controller 400 may generate data segments from the event data to be striped to the plurality of NVM devices NVM1 to NVM5.

The storage controller 400, for example, the RAID controller 410 may determine whether a stripe (e.g., a full stripe) can be formed from (or alternatively, based on) the user data in S330. That is, the storage controller 400 may determine whether a data segment is generated from the user data for each of the plurality of NVM devices NVM1 to NVM5. If the stripe can be formed from the user data in S330, a parity generating circuit 430 may generate parity data from (or alternatively, based on) the plurality of data segments in S340. After generating the parity data, the RAID controller 410 may store the plurality of data segments in corresponding NVM devices NVM1 to NVM5, respectively, and may store the parity data in an NVM device NVM6 to generate the stripe in S350. In some embodiments, after generating the parity data, the RAID controller 410 may store the plurality of data segments in designated areas of the corresponding NVM devices NVM1 to NVM5 and may flush the parity data to generate the stripe. Accordingly, the stripe including the plurality of data segments and the parity data may be stored in the plurality of NVM devices NVM1 to NVM6. In some embodiments, when a data segment is generated for each of the plurality of NVM devices NVM1 to NVM5 from the event data, the storage controller 400 may generate parity data from (or alternatively, based on) the plurality of data segments to generate a stripe that includes the data segments and the parity data.

For example, as shown in FIG. 4, when user data segments UD1, UD2, UD3, UD4, and UD5 correspond to a respective NVM device from the plurality of NVM devices NVM1 to NVM5 are generated from (or alternatively, based on) user data, the storage controller 400 may generate parity data P1 from (or alternatively, based on) the user data segments UD1 to UD5. Accordingly, a stripe (i.e., a full stripe) S1 including the user data segments UD1 to UD5 and the parity data P1 may be formed.

In one or more examples, in a state where a number of data segments that are generated from the user data is less than a number of the plurality of NVM devices NVM1 to NVM5 (e.g., a partial stripe is formed), based on predetermined information (S360), the RAID controller 410 may fill segment(s) of the event data into missing segment(s) in the stripe formed by the user data in S370. The predetermined information may include time information. In some embodiments, the predetermined information may include information indicating that a predetermined period of time has elapsed from a time when the user data is stored in the buffer 420. If the predetermined period of time has elapsed from the time when the user data are stored in the buffer 420 (e.g., there is no update to the user data for the predetermined period of time after the user data are stored in the buffer 420) in S360, the storage controller 400 may fill the missing segment(s) in the stripe formed by the segment(s) of the user data with the segment(s) generated from the event data in S370. The storage controller 400, for example, the parity generating circuit 430 may generate parity data from (or alternatively, based on) the segment(s) of the user data and the segment(s) of the event data in S380. After generating the parity data, the storage controller 400 may store the user data segment(s) and the event data segment(s) in corresponding NVM devices NVM1 to NVM5, and may store the parity data in the NVM device NVM6 to generate a stripe in S390. In some embodiments, the RAID controller 410 of the storage controller 400 may store the user data segment(s), the event data segment(s), and the parity data in the NVM devices NVM1 to NVM6 in S390.

For example, as shown in FIG. 4, in a state where a stripe is partially formed by data segments UD6, UD7, and UD8 generated from (or alternatively, based on) user data, if a predetermined period of time has elapsed from a time when the user data UD6, UD7, and UD8 are stored in the buffer 420, the storage controller 400 may fill the missing parts of a stripe S2 with segments ED1 and ED2 generated from the event data to complete formation of the stripe S2. Accordingly, the stripe (e.g., the full stripe) S2 including the data segments UD6, UD7, UD8, ED1, and ED2, and parity data P2 may be formed.

According to the above-described embodiments, when the user data are stored in the buffer 420, and there is no update to the user data for a predetermined period of time in a state where a stripe is formed, the storage controller 400 may generate the stripe with the user data and the event data. Thus, the user data area 421 of the buffer 420 may be utilized efficiently, and the user data stored in the buffer 420 may be prevented from being lost by an external or internal factor.

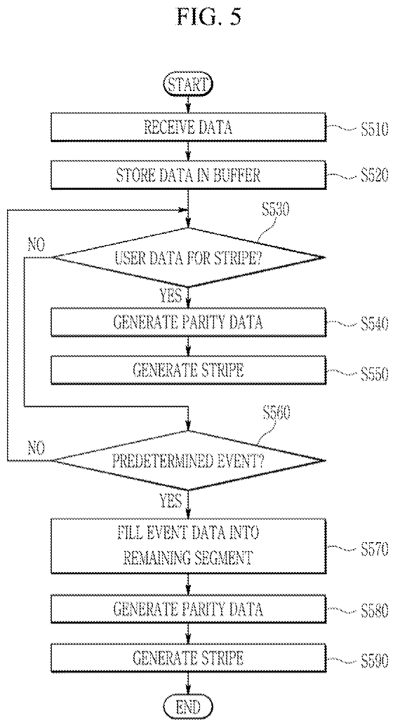

FIG. 5 is a flowchart illustrating an example of an operating method of a storage device for a vehicle according to some embodiments. Some operations shown in FIG. 5 (e.g., operations of S510 to S550 and S570 to S590) are similar to operations described with reference to FIG. 3 (e.g., operations of S310 to S350 and S370 to S390), so detailed descriptions thereof are omitted.

Referring to FIGS. 4 and 5, a storage controller 400 may receive user data from a host in S510, and may store the received user data in a buffer 420 in S520. The storage controller 400 may determine whether a stripe can be formed from (or alternatively, based on) the user data in S530. If a stripe can be formed from the user data in S530, the storage controller 400 may generate parity data (e.g., P1) from (or alternatively, based on) the plurality of user data segments (e.g., UD1 to UD5) in S540. In S550, after generating the parity data P1, the storage controller 400 may store the user data segments (e.g., UD1 to UD5) in a plurality of NVM devices NVM1 to NVM5 and the parity data (e.g., P1) in an NVM device NVM6 to generate a stripe (e.g., S1) including the user data segments (e.g., UD1 to UD5) and the parity data (e.g., P1).

In S570, in a state where a number of generated data segments is less than a number of the plurality of NVM devices NVM1 to NVM5, and when a predetermined event is determined to occur, the storage controller 400 may fill missing parts of a stripe with event data segments (e.g., ED1 and ED2) generated from event data to complete formation of the stripe. The predetermined information may include event information. In some embodiments, the event information may include information indicating occurrence of a predetermined event. Thus, after the user data forming a partial stripe (e.g., UD6, UD7, are UD8) are stored in the buffer 420, if the predetermined event occurs in S560, the storage controller 400 may fill the missing segments in the stripe (e.g., S2) formed by the user data segments (e.g., UD6, UD7, and UD8) with the event data segments (e.g., ED1 and ED2) generated from event data in S570.

In some embodiments, the event information may include speed information of a vehicle equipped with the storage device. In some embodiments, the speed information may be information indicating that a speed of the vehicle equipped with the storage device exceeds a predetermined speed. Thus, after the user data (e.g., UD6, UD7, and UD8) are stored in the buffer 420, if the speed of the vehicle exceeds the predetermined speed in S560, the storage controller 400 may fill the missing segments in the stripe (e.g., S2) formed by the user data segments (e.g., UD6, UD7, and UD8) with the event data segments (e.g., ED1 and ED2) S570 generated from event data in S570.

In S580, a parity generating circuit 430 may generate parity data (e.g., P2) from (or alternatively, based on) the user data segments (e.g., UD6, UD7, and UD8) and the event data segments (e.g., ED1 and ED2). In S590, after generating the parity data P2, the storage controller 400 may store the data segments (e.g., UD6, UD7, UD8, ED1, and ED2) generated from the user data and the event data in the corresponding NVM devices NVM1-NVM5 and may store the parity data (e.g., P2) in the NVM device NVM6 to generate the stripe including the data segments (e.g., UD6, UD7, UD8, ED1, and ED2) generated form the user data and event data, and the parity data (e.g., P2) in S590.

According to the above-described embodiments, if the predetermined event occurs while the user data are stored in the buffer 420 and the stripe is not completely formed (e.g., partial stripe is formed), the storage controller 400 may form the stripe with the user data and the event data. Thus, the user data stored in the buffer 420 may be prevented from being lost due to a factor (e.g., an accident) associated with the predetermined event.

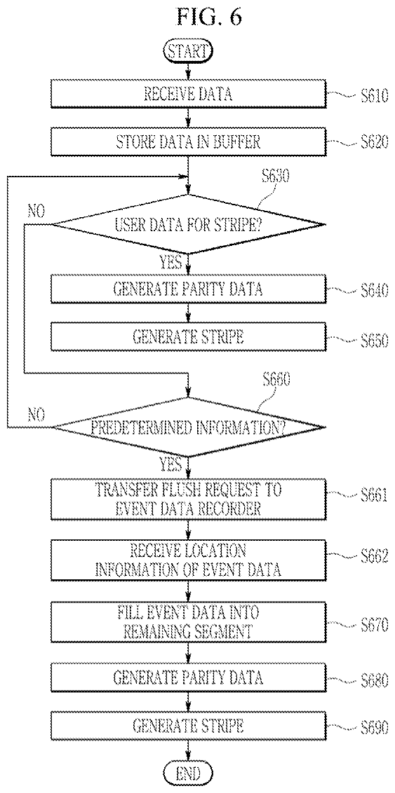

FIG. 6 is a flowchart illustrating an example of an operating method of a storage device for a vehicle according to some embodiments. Some operations shown in FIG. 6 (e.g., operations of S610 to S660 and S670 to S690) are similar to operations described with reference to FIG. 3 or FIG. 5 (e.g., operations of S310 to S390 or S510 to S590), so detailed descriptions thereof are omitted.

Referring to FIGS. 4 and 6, a storage controller 400 may receive user data from a host in S610, and may store the received user data in a buffer 420 in S620. The storage controller 400 may determine whether a stripe can be formed from (or alternatively, based on) the user data in S630. If the stripe can be formed from the user data in S630, the storage controller 400 may generate parity data (e.g., P1) from (or alternatively, based on) a plurality of user data segments (e.g., UD1 to UD5) in S640. In S650, after generating the parity data (e.g., P1), the storage controller 400 may store the user data segments (e.g., UD1 to UD5) in a plurality of NVM devices NVM1-NVM5 and the parity data (e.g., P1) in an NVM device NVM6 to generate a stripe (e.g., S1) including the plurality of user data segments (e.g., UD1 to UD5) and the parity data (e.g., P1).

In S661, in a state where the number of generated data segments from the user event data is less than the number of the plurality of NVM devices NVM1 to NVM5 the RAID controller 410 may forward an event data flush request to an event data recorder 440. In response to the event data flush request, the event data recorder 440 may transfer location information indicating a location where event data segments generated from event data (e.g., ED1 and ED2) are stored in the buffer 420 to the RAID controller 410 in S662. In some embodiments, the location information may include a pointer indicating the location where the event data segments (e.g., ED1 and ED2) are stored or an address of the location where the event data are stored.

In S670, the RAID controller 410 may fill missing segments in a partially formed stripe with the event data segments. In S680, the storage controller 400, for example, a parity generating circuit 430 may generate parity data (e.g., P2) from (or alternatively, based on) the user data segments (e.g., UD6, UD7, and UD8), and the event data segments (e.g., ED1 and ED2). In S690, after generating the parity data (e.g., P2), the storage controller 400 may store the data segments (e.g., UD6, UD7, UD8, ED1, and ED2) comprising the user data segments and the event data segments in the corresponding NVM devices NVM1 to NVM5 and may store the parity data (e.g., P2) in the NVM device NVM6 to generate the stripe (e.g., S2) including the data segments (e.g., UD6, UD7, UD8, ED1, and ED2), and the parity data P2. The storage controller 400 may flush the event data segments (e.g., ED1 and ED2) based on the location information when storing the event data segments (e.g., ED1 and ED2) in S690.

According to the above-described embodiments, the event data recorder 440 may store the event data in the buffer 420 without going through the RAID controller 410. In this case, the RAID controller 410 may forward a flush request to the event data recorder 440, such that the event data recorder 440 may identify the location information of the event data stored in the buffer 420 and may flush the event data based on the location information.

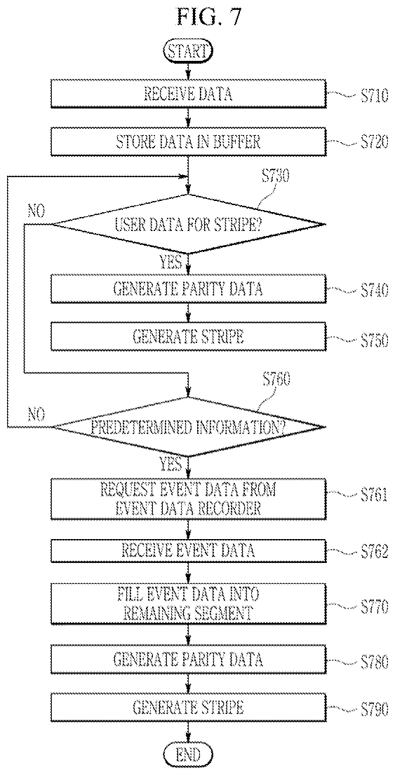

FIG. 7 is a flowchart illustrating an example of an operating method of a storage device for a vehicle according to some embodiments. Some operations shown in FIG. 7 (e.g., operations of S710 to S760 and S770 to S790) are similar to operations described with reference to FIG. 3 or FIG. 5 (e.g., operations of S310 to S390 or S510 to S590). Therefore, detailed descriptions thereof are omitted.

Referring to FIGS. 4 and 7, a storage controller 400 may receive user data from a host in S710, and may store the received user data in a buffer 420 in S720. The storage controller 400 may determine whether a stripe can be formed from (or alternatively, based on) the user data in S730. In S740, if the stripe can be formed from the user data in S730, the storage controller 400 may generate parity data from (or alternatively, based on) a plurality of user data segments. After generating the parity data, the storage controller 400 may store the user data segments (e.g., UD1 to UD5) in a plurality of NVM devices NVM1 to NVM5 and the parity data (e.g., P1) in an NVM device NVM6 to generate a stripe (e.g., S1) including the plurality of user data segments (e.g., UD1 to UD5) and the parity data (e.g., P1) in S750.

In S760, in a state where the number of data segments generated from the user data is less than the number of the plurality of NVM devices NVM1 to NVM5, and when it is determined that predetermined information exists, a RAID controller 410 may request event data from an event data recorder 440 in S761. The event data recorder 440 may store event data segments (e.g., ED1 and ED2) recorded in an internal memory in the buffer 420 in response to the event data request in S762. In some embodiments, after storing the event data (e.g., ED1 and ED2) in the buffer 420, the event data recorder 440 may provide location information of the event data (e.g., ED1 and ED2) to the RAID controller 410.

The RAID controller 410 may fill missing segments in a stripe (e.g., S2) formed by the user data segments (e.g., UD6, UD7, and UD8) with the event data segments (e.g., ED1 and ED2) stored in the buffer 420 in S770. A parity generating circuit 430 may generate parity data (e.g., P2 from (or alternatively, based on) the user data segments (e.g., UD6, UD7, and UD8), and the event data segments (e.g., ED1 and ED2) in S780. After generating the parity data (e.g., P2), the storage controller 400 may store the data segments (e.g., UD6, UD7, UD8, ED1, and ED2) comprising user data segments and event data segments in the corresponding NVM devices NVM1 to NVM5, and may store the parity data (e.g., P2) in the NVM device NVM6 to generate the stripe (e.g., S2) including the data segments (e.g., UD6, UD7, UD8, ED1, and ED2), and the parity data (e.g., P2) in S790. In some embodiments, the storage controller 400 may flush the event data segments (e.g., ED1 and ED2) based on the location information when storing the event data segments (e.g., ED1 and ED2) in S790.

According to the above-described embodiments, when the number segments is insufficient when the RAID controller 410 forms a stripe, the RAID controller 410 may request event data from the event data recorder 440 to fill missing segments with the event data.

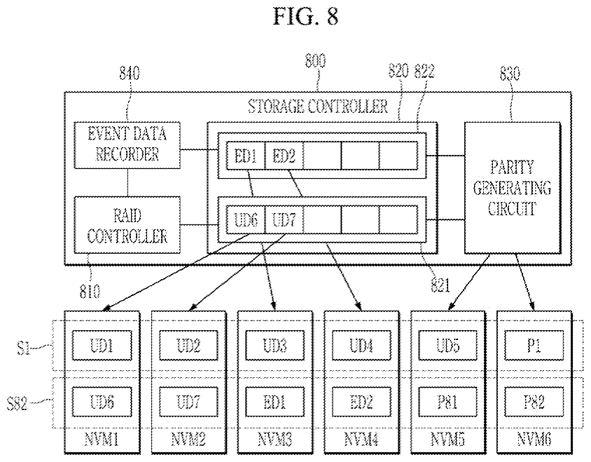

FIG. 8 is a diagram illustrating an example of an operating method of a storage device for a vehicle according to some embodiments. It is assumed in FIG. 8 that the storage device includes six NVM devices NVM1 to NVM6.

Referring to FIG. 8, a storage controller 800, for example, a RAID controller 810 of the storage controller 800 may receive user data UD1 to UD5 from a host, may store the received user data UD1 to UD5 in a buffer 820 (e.g., a user data area 821 of the buffer 820), and may generate parity data P1 from (or alternatively, based on) the user data UD1 to UD5 using a parity generating circuit 830. The RAID controller 810 may flush a stripe S1 including the user data UD1 to UD5 and the parity data P1 to a plurality of NVM devices NVM1 to NVM6.

In one or more examples, if the storage controller 800 is unable to form a complete stripe S82 with user data UD6 and UD7 received from the host (e.g., partial stripe is formed), the storage controller 800 may fill in missing segments of the stripe S82 with event data ED1 and ED2 provided from the event data recorder 840. The parity generating circuit 830 may generate different parity data P81 and P82 from (or alternatively, based on) the user data segments UD6 and UD7 stored in the user data area 821 of the buffer 820 and the event data segments ED1 and ED2 stored in an event data area 822 of the buffer 820. The RAID controller 810 may generate the stripe S82 including the user data segments UD6 and UD7, the event data segments ED1 and ED2, and the parity data P81 and P82.

In some embodiments, the parity generating circuit 830 may generate the parity data P81 from (or alternatively, based on) the user data segments UD6 and UD7 and the event data segments ED1 and ED2, and may generate the parity data P82, different from the parity data P1, from (or alternatively, based on) the user data segments UD6 and UD7 and the event data segments ED1 and ED2.

In some embodiments, the parity generating circuit 830 may perform ECC encoding on the user data segments UD6 and UD7 and the event data segments ED1 and ED2 using a first ECC to generate the parity data P81, and may perform the ECC encoding on the user data segments UD6 and UD7 and the event data segments ED1 and ED2 using a second ECC different from the first ECC to generate the parity data P82.

In some embodiments, the parity generating circuit 830 may perform the ECC encoding on the user data segments UD6 and UD7 to generate the parity data P81, and may perform the ECC encoding on the event data segments ED1 and ED2 to generate the parity data P82.

In some embodiments, the parity generating circuit 830 may generate the parity data P81 from (or alternatively, based on) the event data segments ED1 and ED2, and generate the parity data P82, different from parity data P1, from (or alternatively, based on) the user data segments UD6 and UD7 and the event data segments ED1 and ED2.

According to the above-described embodiments, by generating a plurality of parity data of different types in a stripe including user data and event data, the reliability of the event data may be increased.

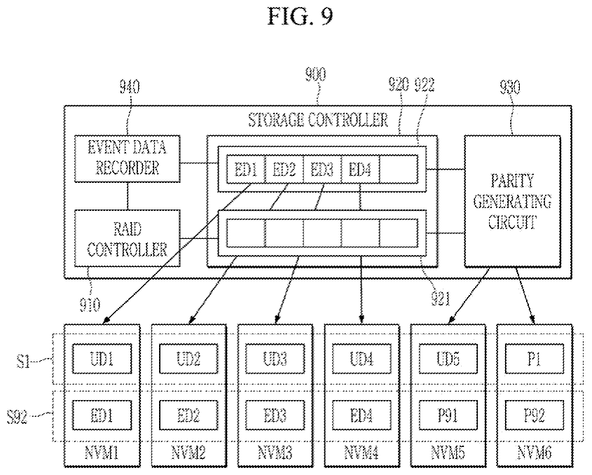

FIG. 9 is a diagram illustrating an example of an operating method of a storage device for a vehicle according to some embodiments. In one or more examples, as illustrated in, a storage device includes six NVM devices NVM1 to NVM6.

Referring to FIG. 9, a storage controller 900, for example, a RAID controller 910 of the storage controller 900 may receive user data UD1 to UD5 from a host, may store the received user data UD1 to UD5 in a buffer 920, for example, a user data area 921 of the buffer 920, and may generate parity data P1 from (or alternatively, based on) the user data UD1 to UD5 using a parity generating circuit 930. The RAID controller 910 may flush a stripe S1 including the user data UD1 to UD5 and the parity data P1 to a plurality of NVM devices NVM1 to NVM6.

In one or more examples, the storage controller 900 may form a stripe S92 with event data ED1, ED2, ED3, and ED4 that are stored in an event data area 922 of the buffer 920 by an event data recorder 940 without using the user data. The parity generating circuit 830 may generate parity data P91 from the event data segments ED1 to ED4 stored in the buffer 920, and may further generate parity data P92 different from the parity data P91 from (or alternatively, based on) the event data segments ED1 to ED4. The RAID controller 910 may generate the stripe S92 including the event data segments ED1 to ED4 and the parity data P91 and P92.

In some embodiments, the parity generating circuit 930 may perform ECC encoding on the event data segments ED1 to ED4 using a first ECC to generate the parity data P91, and may perform the ECC encoding on the event data segments ED1 to ED4 using a second ECC different from the first ECC to generate the parity data P92.

According to the above-described embodiments, by generating a plurality of parity data of different types in a stripe including event data, the reliability of the event data may be increased.

While FIGS. 3 to 9 have been described by using a storage device (400 of FIG. 4) similar to the storage device described with reference to FIG. 1 as an example, the operating method of the storage device described with reference to FIGS. 3 to 9 may also be applied to a storage device illustrated in FIG. 2.

In some embodiments, the storage device described with reference to FIGS. 1 to 9 may be mounted on a storage system other than a vehicle. In some embodiments, event data may include event data indicating a change in a state of the storage system.

While the disclosed embodiments have been described in connection with what is presently considered to be practical embodiments, it is to be understood that the disclosed embodiments are not limited to the disclosed embodiments. On the contrary, it is intended to cover various modifications and equivalent arrangements included within the spirit and scope of the appended claims.

What is claimed is:

1. A storage device comprising:
a plurality of non-volatile memory devices each configured to store a respective segment from a plurality of segments forming a stripe, the plurality of segments comprising a plurality of first segments and at least one second segment;
a buffer configured to store user data and event data of a vehicle;
a parity generating circuit configured to generate parity data corresponding to the at least one second segment based on data corresponding to the plurality of first segments; and
a controller configured to:
generate at least one user data segment corresponding to at least one first segment from the plurality of first segments based on the user data,
generate, based on predetermined information generated in a state in which the at least one user data segment is generated, at least one event data segment based on the event data corresponding to at least one first segment from the plurality of first segments that is different from the first segment corresponding to the user data segment, and
store the stripe comprising the at least one user data segment, the at least one event data segment, and the parity data in the plurality of non-volatile memory devices.

2. The storage device of claim 1, wherein the predetermined information comprises time information.

3. The storage device of claim 2, wherein the time information comprises information indicating that a predetermined period of time has elapsed after the user data is stored in the buffer.

4. The storage device of claim 1, wherein the predetermined information comprises event information.

5. The storage device of claim 4, wherein the event information comprises information indicating occurrence of a predetermined event after the user data is stored in the buffer.

6. The storage device of claim 5, wherein the predetermined event comprises an event in which a speed of the vehicle exceeds a predetermined speed.

7. The storage device of claim 1, wherein the controller is further configured to:
forward, based on the predetermined information, a flush request to an event data recorder that has stored the event data in the buffer,
receive location information of the event data that the event data recorder transfers in response to the flush request, and
flush the at least one event data segment based on the location information to store the stripe in the plurality of non-volatile memory devices.

8. The storage device of claim 1, wherein the controller is further configured to request, based on the predetermined information, an event data recorder to store the event data in the buffer.

9. The storage device of claim 8, wherein the controller is further configured to:
receive location information of the event data from the event data recorder, and
flush the at least one event data segment based on the location information to store the stripe.

10. The storage device of claim 1, wherein the parity data comprises first parity data and second parity data having a different type from the first parity data, and
wherein the at least one second segment comprises a plurality of second segments corresponding to the first parity data and the second parity data.

11. The storage device of claim 1, wherein the buffer is further configured to store second event data of the vehicle,
wherein the controller is further configured to generate, based on the second event data, a plurality of second event data segments each corresponding to a respective first segment from the plurality of first segments,
wherein the parity generating circuit is further configured to generate a plurality of second parity data based on the plurality of second event data segments, each second parity data generated based on a different type of correction code, and
wherein the at least one second segment comprises a plurality of second segments respectively corresponding to the plurality of second parity data.

12. A storage controller of a storage device configured to be used in a storage system, the storage controller comprising:
a buffer configured to store user data and event data of the storage system;
a parity generating circuit; and
a redundant array of inexpensive disks (RAID) controller configured to:
control a plurality of non-volatile memory devices comprised in the storage device in a RAID manner;
form a partial stripe of a full stripe based on the user data;
fill missing segments of the partial stripe with the event data based on predetermined information to form the full stripe; and
store the full stripe comprising the user data, the event data, and parity data generated by the parity generating circuit in the plurality of non-volatile memory devices.

13. The storage controller of claim 12, wherein the predetermined information comprises time information.

14. The storage controller of claim 13, wherein the time information comprises information indicating that a predetermined period of time has elapsed after the user data are stored in the buffer.

15. The storage controller of claim 12, wherein the predetermined information comprises event information.

16. The storage controller of claim 15, wherein the event information comprises information indicating occurrence of a predetermined event after the user data is stored in the buffer.

17. The storage controller of claim 12, wherein the event data comprise event data indicating a change in a state of the storage system.

18. The storage controller of claim 12, wherein the RAID controller is further configured to:
forward, based on the predetermined information, a flush request to an event data recorder that has stored the event data in the buffer;
receive location information of the event data that the event data recorder transfers in response to the flush request; and
flush the event data based on the location information to store the full stripe in the plurality of non-volatile memory devices.

19. The storage controller of claim 12, wherein the RAID controller is further configured to request, based on the predetermined information, the event data recorder to store the event data in the buffer.

20. A method of operating a storage device, the method comprising
forming a stripe for storage in a redundant array of inexpensive disks (RAID) manner based on user data;
in a state in which a partial stripe of the stripe is formed based on the user data, obtaining predetermined information;
filling missing segments of the partial stripe with event data of a vehicle based on the predetermined information to form a full stripe;
generating parity data based on the user data and the event data; and
storing the full stripe comprising the user data, the event data, and the parity data in a plurality of non-volatile memory devices comprised in the storage device.
